(19) United States
(12) Patent Application Publication
(10) Pub. No.: US 2026/0322721 A1
(43) Pub. Date: Oct. 15, 2026

(54) SIGNALING AND DETERMINING IDLE PERIODS DURING REAL-TIME TRAFFIC COMMUNICATION

(71) Applicant: QUALCOMM Incorporated, San Diego, CA (US)

(72) Inventors: Liangping Ma, San Diego, CA (US); Thomas Stockhammer, Bergen (DE); Imed Bouazizi, Celina, TX (US); Nikolai Konrad Leung, San Francisco, CA (US)

(21) Appl. No.: 19/536,900

(22) Filed: Feb. 11, 2026

Related U.S. Application Data
(60) Provisional application No. 63/758,069, filed on Feb. 13, 2025.

(51) Int. Cl. H04L 43/0852; H04L 65/65; H04L 65/80; H04N 19/70

(52) U.S. Cl. CPC H04L 43/0852; H04L 65/65; H04L 65/80; H04N 19/70

(57) ABSTRACT

A device for receiving data via a network includes: a memory configured to store data; and a processing system implemented in circuitry and configured to: receive data indicating whether burst information is included with a current packet of a communication session; and when the data indicates that the current packet includes the burst information: determine whether the burst information includes either or both of data representing a minimum time between a time of transmission of the current packet and a time of transmission of a subsequent packet of the communication session or data representing a burst size for a burst including the current packet; and use the burst information to receive the subsequent packet.

This application claims the benefit of U.S. Provisional Application No. 63/758,069, filed Feb. 13, 2025, the entire contents of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for exchanging data via a network, such as media data. The network may be a radio access network (RAN), such as a 5G network. Media data, such as video data, may take variable amounts of time to encode and transmit. For example, a frame of video data following a scene change may require more time to encode than a frame of video data following another frame of the same scene. Thus, predicting precise timing between packets of data sent via the network may be difficult when the packets include frames of video data. Therefore, rather than signaling a precise time to next burst (TTNB) value, the techniques of this disclosure include signaling a minimum time between a time of transmission of a previous packet and a time of transmission of a subsequent packet.

In this manner, the sending device may determine a minimum amount of time required to, e.g., encode and send packets corresponding to various frames of video data and signal this minimum amount of time. Therefore, a client device or other receiving device may deactivate reception circuitry to save power, while also ensuring that the reception circuitry is active at the time required to receive the subsequent packet. As such, signaled times between packets may be reduced, thereby reducing latency for transmissions, while also preserving the ability of the client device to save power between packet transmissions.

Furthermore, this disclosure describes techniques by which the minimum time may be adaptively signaled for some, but not all, packets for a particular communication session. In some cases, the minimum time may be so small that there may be little benefit to signaling the minimum time and to disabling/enabling reception of data. Thus, per techniques of this disclosure, a sending device may determine whether to signal the minimum time value (e.g., idle period value or TTNB value).

In one example, a method of receiving data via a network includes: receiving data indicating whether burst information is included with a current packet of a communication session; and when the data indicates that the current packet includes the burst information: determining whether the burst information includes either or both of data representing a minimum time between a time of transmission of the current packet and a time of transmission of a subsequent packet of the communication session or data representing a burst size for a burst including the current packet; and using the burst information to receive the subsequent packet.

In another example, a device for receiving data via a network includes: a memory configured to store data; and a processing system implemented in circuitry and configured to: receive data indicating whether burst information is included with a current packet of a communication session; and when the data indicates that the current packet includes the burst information: determine whether the burst information includes either or both of data representing a minimum time between a time of transmission of the current packet and a time of transmission of a subsequent packet of the communication session or data representing a burst size for a burst including the current packet; and use the burst information to receive the subsequent packet.

In another example, a method of sending data via a network includes: determining a minimum time between a time of transmission of a current packet of a packet flow being sent to a client device and a time of transmission of a subsequent packet of the packet flow and a burst size for a data burst including the current packet; in response to determining to signal burst information for the current packet, sending information to the client device indicating that the burst information is signaled for the current packet and signaling the burst information, the burst information including at least one of the minimum time between the time of transmission of the current packet and the time of transmission of the subsequent packet or the burst size; sending the current packet to the client device; and at or after a time corresponding to the minimum time following the time of transmission of the current packet, sending the subsequent packet to the client device.

In another example, a device for sending data via a network, the device comprising: a memory configured to store data; and a processing system implemented in circuitry and configured to: determine a minimum time between a time of transmission of a current packet of a packet flow being sent to a client device and a time of transmission of a subsequent packet of the packet flow and a burst size for a data burst including the current packet; in response to determining to signal burst information for the current packet, send information to the client device indicating that the burst information is signaled for the current packet and signaling the burst information, the burst information including at least one of the minimum time between the time of transmission of the current packet and the time of transmission of the subsequent packet or the burst size; send the current packet to the client device; and at or after a time corresponding to the minimum time following the time of transmission of the current packet, send the subsequent packet to the client device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating elements of an example video file.

FIG. 3 is a block diagram illustrating an example set of network devices that may perform various aspects of the techniques of this disclosure.

FIG. 4 is a conceptual diagram illustrating packet structures for packets sent between various network devices.

FIG. 5 is a flowchart illustrating an example method of sending data of a communication session via a network according to techniques of this disclosure.

FIG. 6 is a flowchart illustrating an example method of receiving data of a communication session via a network according to techniques of this disclosure.

### DETAILED DESCRIPTION

In general, this disclosure describes techniques for transmitting data via a network, such as a radio access network (RAN). In some techniques, a data burst is defined as a set of multiple protocol data units (PDUs) generated and sent by an application such that there is an idle period between two data bursts. A data burst can include one or more PDU Sets.

Indications of data burst characteristics (such as burst size and time to next burst (TTNB)) are intended to be exposed to intermediate network devices (e.g., intermediate routers) between a sending device and a receiving device. A user plane function (UPF) device may be one of the intermediate network devices. Exposure of the data burst characteristics to the intermediate network devices may allow for cross-layer optimization. For example, in a cellular downlink: an application server device may send an RTP packet whose RTP header extension indicates data burst information. A UPF device may extract the data burst information from the RTP header extension of the RTP packet that carries the indications, copy the information into a GPRS tunneling protocol user data (GTP-U) packet header of a GTP-U packet that encapsulates the RTP packet, and send the GTP-U packet to a base station of a radio access network (RAN) via a network tunnel. The base station may use the data burst information of the GTP-U packet header for scheduling and UE power savings options.

In some techniques, a time to next burst (TTNB) value represents a time interval between transmission of a last packet in a current burst and a first packet of a next burst, i.e., inter-burst time. This disclosure recognizes that this definition of TTNB may result in problems in some cases. For example, when transmitting live video data (i.e., video data being recorded in real time), the video encoding time can be highly variable and rate adaptation can change a time when the next frame can be generated. Furthermore, it is difficult for the sending device to determine precisely when the first packet of the next burst will be created.

This disclosure describes techniques that may be used to address timing uncertainty at the sending device side due to application layer behavior (e.g., multimedia encoding, congestion control, and/or rate control). Per techniques of this disclosure, an idle period (i.e., a time between transmission of data bursts) may be defined such that the idle period is more general than the conventional TTNB value. Attributes for data bursts may include burst identifiers, and the idle period concept of this disclosure may be used without the context of a data burst. For example, if a data burst is relatively long, e.g., 6 ms, the idle period may signal a time gap within the data burst, which can help with client device (e.g., user equipment (UE) device) power saving. For TTNB, the idle period may be particularized to retain its ability to handle timing uncertainty.

Per this disclosure, an idle period may be defined as a time period during which the sending device will not send (transmit) any packet, where the starting point of the idle time period may be the time of transmission of the packet that carries the idle period indication. The idle period may therefore serve as a minimum time period during which no traffic leaves the sending device. Thus, it is possible that the sending device may continue to refrain from sending traffic after the idle period. The idle period may be applied to data bursts to redefine the TTNB value, such that a redefined TTNB value per these techniques is the minimum amount of time to be elapsed from the transmission of the last packet in the current data burst to the transmission of the first packet of the next burst.

In this manner, the idle period definition or the newly defined TTNB value may easily allow the sending device to account for delays between packets, e.g., video encoding delay, which is variable even if video frame rate is constant. For example, assuming the video encoding delay varies from 1 to 3 ms, the nominal frame rate is 60 fps, and the spread of packets of a frame is negligible, with the conventional definition of TTNB, it would be difficult for the sending device to determine when the next frame will be sent out. However, per techniques of this disclosure, for example, the sending device may determine a maximum extra encoding delay of 2 ms and a time between frames of 16.67 ms, then signal the difference as 14.67 ms (16.67 ms-2 ms) as the minimum time between packet bursts.

As such, the idle period may represent a minimum amount of time that a sending device guarantees no traffic will be sent to the network. This may be beneficial because it is generally difficult for the sending device to predict when multimedia encoding, such as video encoding, will be completed for a particular data burst/subsequent packet. Conventional TTNB, redefined TTNB, and/or idle period data for traffic timing information may be used for techniques of this disclosure.

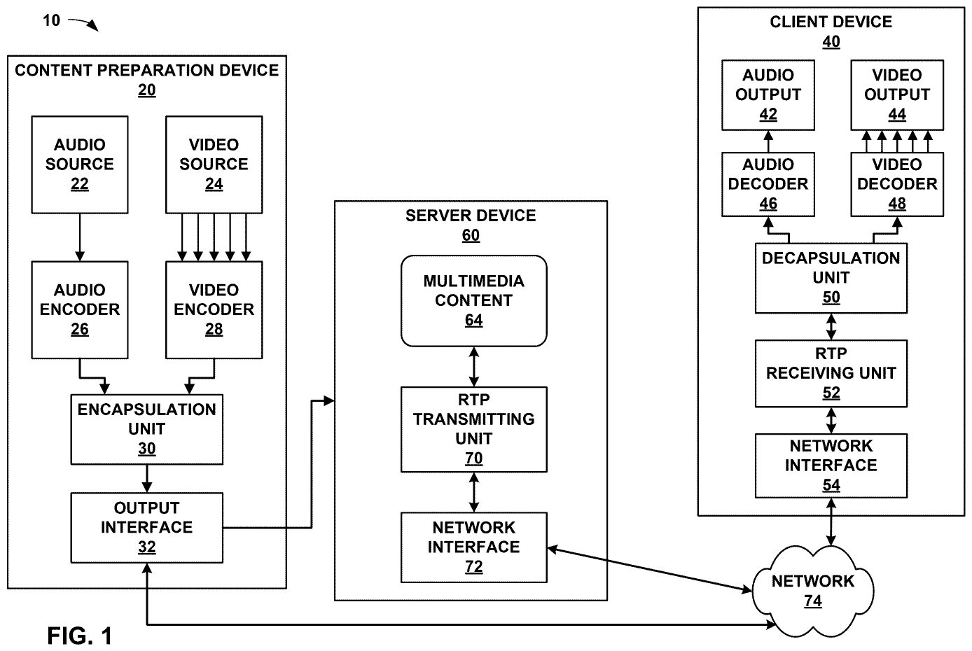

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized as Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and supplemental enhancement information (SEI) NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded picture samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of scalable video coding (SVC) and view scalability information SEI messages in multiview video coding (MVC). These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of media content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement User Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

In some examples, server device 60 determines a minimum time between a time of transmission of a current packet of a packet flow being sent to client device 40 and a time of transmission of a subsequent packet of the packet flow. Server device 60 may also (additionally or alternatively) determine a burst size for a data burst including the current packet. Server device 60 may determine whether to signal either or both of the minimum time and/or the burst size in the current packet. In response to determining to signal burst information for the current packet, server device 60 sends information to client device 40 indicating that the burst information is signaled for the current packet (e.g., one or more flags indicating inclusion of the minimum time and/or the burst size). Server device 60 may signal these flags in an RTP header extension. In response to determining to signal the burst information, server device 60 also signals the burst information. The burst information may include either or both of the minimum time between the time of transmission of the current packet and the time of transmission of the subsequent packet and/or the burst size.

Server device 60 sends the current packet to client device 40. At or after a time corresponding to the minimum time following the time of transmission of the current packet, server device 60 sends the subsequent packet to client device 40. In some examples, server device 60 may signal the burst size and the minimum time (e.g., an idle period) in different packets of a current data burst. For example, server device 60 may signal the burst size in an ordinal first packet of the current data burst and the minimum time/idle period in an ordinal last packet of the current data burst. In some examples, server device 60 may signal a predicted burst size for a subsequent data burst in a packet of a current data burst. In some examples, server device 60 may signal the minimum time/idle period in any packet of the current data burst, but the minimum time/idle period is to be interpreted relative to an ordinal last packet of the current data burst. That is, the minimum time may represent a time between transmission of the ordinal last packet (which may be a different packet than the packet including the minimum time data) of a current data burst and an ordinal first packet of a subsequent data burst.

Client device 40 receives the data indicating whether burst information is included with the current packet of the communication session. When the data indicates that the current packet includes the burst information, client device 40 determines whether the burst information includes either or both of data representing the minimum time between the time of transmission of the current packet and the time of transmission of the subsequent packet of the communication session or data representing the burst size for the burst including the current packet. Client device 40 uses the burst information to receive the subsequent packet. For instance, client device 40 may disable reception circuitry for the communication session for a time equal to the minimum time/idle period. After the minimum time following time of reception of the current packet, client device 40 may reenable the reception circuitry for the communication session to receive the subsequent packet. Additionally or alternatively, client device 40 may disable the reception circuitry after an amount of data equal to the burst size for the current burst has been received.

By using the specific arrangement of signaling a minimum time between the time of transmission of a current packet and the time of transmission of a subsequent packet (e.g., an idle period), system 10 may improve power management at client device 40. For instance, because video encoding times may vary, predicting a precise time to next burst (TTNB) is often difficult for server device 60 (and/or content preparation device 20). By determining and signaling a minimum guaranteed idle period instead of a precise TTNB, server device 60 accommodates this processing uncertainty while still providing actionable timing information to client device 40. Consequently, client device 40 may disable reception circuitry for the duration of the idle period to reduce power consumption, ensuring the reception circuitry is re-enabled in time for the subsequent packet, thereby improving battery life without risking data loss due to jitter or processing variance.

Furthermore, the techniques for adaptively signaling whether the burst information includes the minimum time, the burst size, or both, may reduce communication overhead within network 74. For example, in scenarios where data bursts are short or traffic is not bursty, signaling all burst parameters may be unnecessary and consume bandwidth. By configuring server device 60 to selectively include the relevant data burst information and signaling the presence of such information, system 10 minimizes header overhead in the real-time transport protocol (RTP) packets. This reduction in overhead may effectively increase available bandwidth for media content 64, potentially reducing latency and improving the overall quality of experience for the user of client device 40.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

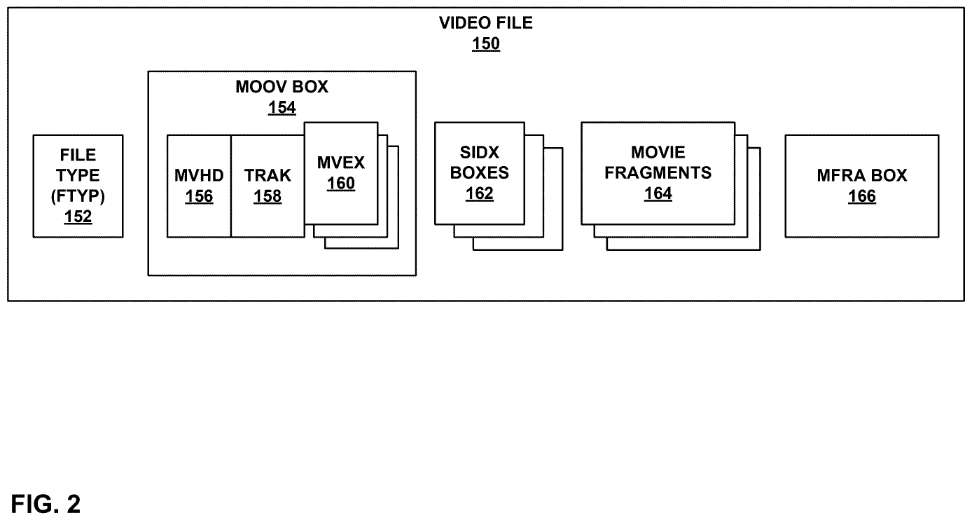

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture includes one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

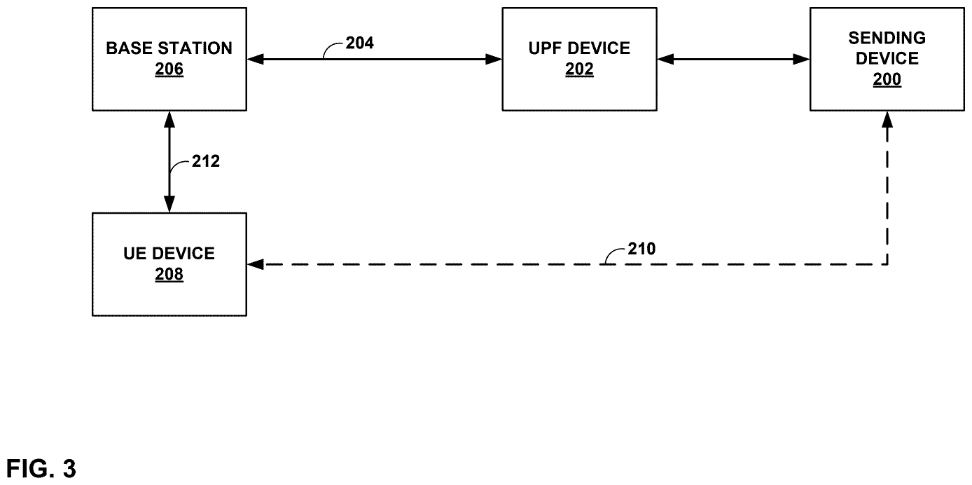

FIG. 3 is a block diagram illustrating an example set of network devices that may perform various aspects of the techniques of this disclosure. The example of FIG. 3 depicts sending device 200, user plane function (UPF) device 202, base station 206, and user equipment (UE) device 208. Sending device 200 may correspond to server device 60 and/or content preparation device 20 of FIG. 1. UE device 208 may correspond to client device 40 of FIG. 1.

Sending device 200 (e.g., an application server (AS) device) may obtain video data to be sent to UE device 208 via communication session 210. To send the video data to UE device 208, sending device 200 may encode the video data (or receive encoded video data from an encoding device, not shown in FIG. 3). Sending device 200 may encapsulate packets including encoded video data (e.g., encoded slices of frames of video data) to form real-time transport protocol (RTP) packets. Sending device 200 may add an RTP header extension to the RTP packets, where the RTP header extension includes data representing an idle period indicating a minimum time between a time of transmission of a current RTP packet and a time of transmission of a subsequent RTP packet. As the RTP packets are formed, sending device 200 may send the RTP packets to UE device 208 via a network including UPF device 202. Although not shown in FIG. 3, there may be additional network devices between sending device 200 and UPF device 202, e.g., various network routing devices, gateways, bridges, switches, or the like.

In some examples, sending device 200 determines a minimum time between a time of transmission of a current packet of a packet flow being sent to UE device 208 and a time of transmission of a subsequent packet of the packet flow. For example, the current packet may be a packet of a current data burst, and the subsequent packet may be a packet of a subsequent data burst. Alternatively, the current packet and the subsequent packet may be included within the same data burst. Sending device 200 may determine whether to signal the minimum time based on whether the minimum time is greater than a configured threshold value.

Sending device 200 may also (additionally or alternatively) determine a burst size for a data burst including the current packet. In response to determining to signal burst information for the current packet, sending device 200 sends information to UE device 208 indicating that the burst information is signaled for the current packet. Sending device 200 also signals the burst information in response to determining to signal the burst information. The burst information may include either or both of the minimum time between the time of transmission of the current packet and the time of transmission of the subsequent packet and/or the burst size. Sending device 200 sends the current packet to UE device 208. At or after a time corresponding to the minimum time following the time of transmission of the current packet, sending device 200 sends the subsequent packet to UE device 208.

UPF device 202 may receive the RTP packets from sending device 200 and form GTP-U tunneled packets. For example, UPF device 202 may encapsulate the RTP packets with respective GTP-U headers. Per techniques of this disclosure, UPF device 202 may extract the minimum time value from the RTP header extensions of the RTP packets and timestamps indicating times at which the RTP packets were transmitted by sending device 200, e.g., from respective RTP header extensions. UPF device 202 may also compare differences between the timestamps to differences between times of reception of the packets to measure network jitter. UPF device 202 may then form the GTP-U headers to include a modified idle period time according to the signaled minimum time values and the network jitter. UPF device 202 may send the GTP-U packets to base station 206 via network tunnel 204. Network tunnel 204 may include other network devices, such as network routing devices, configured to forward the GTP-U packets along network tunnel 204 to base station 206.

In some examples, UPF device 202 may directly copy the data burst information (e.g., the minimum time value and/or the burst size) from the RTP header extension to the GTP-U packet header without modification. In such examples, UPF device 202 exposes the application layer statistics directly to base station 206, allowing base station 206 to perform its own scheduling or power saving calculations based on the raw data provided by sending device 200.

Base station 206 may receive the GTP-U packets and decapsulate the GTP-U packets to reproduce the RTP packets. Base station 206 may allocate resources to reception of the GTP-U packets based on the modified idle time period. Base station 206 may then send the RTP packets to UE device 208 via radio access network (RAN) connection 212.

UE device 208 may receive the RTP packets from base station 206 via RAN connection 212. In particular, UE device 208 may be a battery powered device, such as a cellphone. Thus, to preserve battery power, UE device 208 may disable reception of packets for communication session 210 via RAN connection 212 for idle period times indicated by the minimum time between time of transmission of a previous packet and time of transmission of a subsequent packet of communication session 210. For example, during the idle period times, UE device 208 may power down reception circuitry, then power up the reception circuitry at the end of the idle period.

In some examples, per techniques of this disclosure, sending device 200 may adaptively determine whether to signal data burst information, e.g., in an RTP header extension. For example, sending device 200 may signal idle period data and/or TTNB data in an RTP header extension for some, but not necessarily all, packets of a packet flow for a media presentation, e.g., as part of communication session 210. When burst duration is short, e.g., less than 1 ms, there may not be any benefit to signaling the burst size, because base station 206 may receive the entire burst in one time slot, assuming the slot size is 1 ms and/or subcarrier spacing is 15 kHz. When the burst is not bursty, for example, packets are spread out evenly in time, there is also no need to signal the idle period because the idle period may be practically zero.

In cases where sending device 200 determines to signal the idle period (or TTNB value or other data burst information indicating a minimum time between a time of transmission of a previous packet and a time of transmission of a subsequent packet), sending device 200 may signal such information in an RTP header extension. In some examples, sending device 200 and UE device 208 may exchange session description protocol (SDP) data, such as an SDP offer and an SDP answer, to establish communication session 210. The SDP offer and/or SDP answer may include data defining the RTP header extension. An augmented Backus-Naur form (ABNF) for an “extmap” attribute may be as follows:
extensionname=“urn:3gpp:idle-period:rel-19”
extensionattributes=[format SP]
format=“short”/“long”

For example, the following SDP attribute in an SDP offer and SDP answer message may indicate that an RTP header extension with identifier 5 and short format carries the idle period data: “a=extmap:5urn:3gpp:idle-period:rel-19 short.”

The “extmap” attribute and the negotiation mechanism for the RTP header extension may be defined according to IETF Request for Comments (RFC) 8285, “A General Mechanism for RTP Header Extensions.” Accordingly, the ABNF syntax for the “extmap” attribute may conform to the definitions provided therein, as modified for the specific extensions described in this disclosure.

The idle period may be carried alone in an RTP header extension, or in an RTP header extension that also carries other information, e.g., about data burst traffic characteristics. In some examples, sending device 200 may signal whether such an RTP header extension including data burst traffic characteristics also includes the idle period data.

In some examples, sending device 200 may construct an RTP header extension to carry burst timing information without the burst size information, where the burst timing information may be one of an idle period or a TTNB value. The idle period value may be a minimum TTNB or redefined TTNB representing a minimum time between a time of transmission of a previous packet and a time of transmission of a subsequent packet.

Alternatively, in some examples, sending device 200 may construct the RTP header extension to carry a standard TTNB value, which represents a time from the time of transmission of a packet in a current data burst to a time of transmission of a first packet of a next data burst. Alternatively, the RTP header extension may carry the burst size data without the timing information. This may be useful when the traffic is not bursty (e.g., packets are evenly spaced in time), such that there is no need to indicate the burst timing information and thus, the burst size information is present in the RTP header extension without the burst timing information. As still another example, the RTP header extension may carry both the burst size and the timing information.

In some examples, sending device 200 may dynamically determine and indicate which of the fields for burst information are present in the RTP header extension. For example, sending device 200 may implicitly indicate whether the RTP header extension includes burst size and/or burst timing information by signaling a length of the RTP header extension, assuming that the burst size is signaled using N bits and the burst timing information is signaled using M bits where N and M are non-equal integer values. Alternatively, sending device 200 may explicitly indicate whether the RTP header extension includes the burst size and/or burst timing information using an indicator, such as a bit map where each bit is mapped to a field and a value of ‘1’ for a bit indicates that the field is present or a value of ‘0’ for the bit indicates that the field is not present.

For instance, a first bit of the bit map (e.g., a first syntax element such as the most significant bit) may correspond to the burst timing information (e.g., the idle period or TTNB), while a second bit of the bit map (e.g., a second syntax element such as the next significant bit) may correspond to the burst size information. In this example, setting the first bit to ‘1’ indicates the presence of the minimum time field, and setting the second bit to ‘1’ indicates the presence of the burst size field. This allows for flexible signaling where sending device 200 may include either or both fields dynamically on a per-packet basis.

In this implicit signaling example, the distinct lengths (N and M) of the fields serve as the discriminator for the receiving device (e.g., UE device 208 or UPF device 202) to identify which information is present. This implicit method may be available when the burst size and the burst timing information are configured to have different bit lengths, thereby avoiding ambiguity based on the total length of the extension.

As still another example, sending device 200 may signal static or semi-static indications of the burst size and/or burst timing information using SDP signaling. For example, the ABNF syntax for the “extmap” attribute may be as follows:
extensionname=“urn:3gpp:dynamic-traffic-characteristics:rel-19”
extensionattributes=[format SP] fields
format=“short”/“long”
fields=“idle-period”/“burst-size”/“both”

For example, the following SDP attribute may indicate that the RTP header extension with identifier (ID) 7 and short format carries both the idle period and the burst size: “a=extmap:7urn:3gpp:dynamic-traffic-characteristics:rel-19 short both.”

By signaling a minimum time between transmission of the current packet and the subsequent packet, sending device 200 may enhance power conservation at UE device 208 and improve resource allocation abilities of base station 206. For example, predicting an exact time for the next data burst may be challenging due to variable encoding delays for video data. By signaling a minimum idle period instead, sending device 200 may provide a window during which no data will be sent. UE device 208 may rely on this minimum idle period to disable reception circuitry for a corresponding time period, thereby reducing power consumption without increasing the likelihood of packet loss.

Additionally, exposing the data burst information to intermediate network devices, such as UPF device 202, may facilitate cross-layer optimization. UPF device 202 may extract the minimum time or burst size from the packet headers and forward the information to base station 206. Base station 206 may utilize the burst information to improve scheduling of radio resources for UE device 208 and allocation of resources of base station 206 itself. Furthermore, by selectively signaling the relevant burst parameters, sending device 200 may reduce the overhead introduced into the network tunnel between UPF device 202 and base station 206, which may increase the efficiency of data transport within the radio access network.

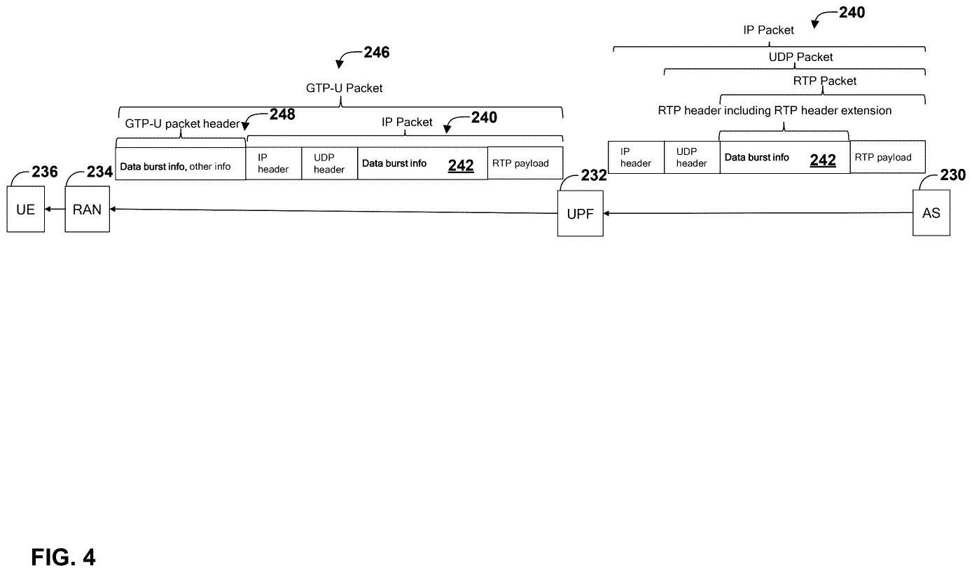

FIG. 4 is a conceptual diagram illustrating packet structures for packets sent between various network devices. For example, FIG. 4 depicts AS device 230, which may correspond to sending device 200 of FIG. 3; UPF device 232, which may correspond to UPF device 202 of FIG. 3; RAN 234, which may correspond to base station 206 and RAN 212 of FIG. 3; and UE device 236, which may correspond to client device 208 of FIG. 3.

FIG. 4 also illustrates packet 240. Packet 240 includes data burst information 242. Packet 240 represents an Internet protocol (IP) packet that encapsulates a UDP packet, which encapsulates an RTP packet including an RTP header including an RTP header extension including data burst information 242. The RTP packet also includes an RTP payload including, e.g., media data. Data burst information 242 includes data indicating whether additional data burst information is signaled and, when present, the additional data burst information. The additional data burst information may include an idle period, a time to next burst value, or a burst size value.

UPF device 232 encapsulates packet 240 to form GTP-U packet 246. GTP-U packet 246 includes GTP-U packet header 248. GTP-U packet header 248 includes data burst information 242, as well as other GTP-U tunneling information. A base station of RAN 234 may use the data burst information to allocate resources to receive the packets of the data burst. UE device 236 may use the data burst information to configure UE device 236 to enter a sleep state or a low power mode.

Per techniques of this disclosure, data burst information 242 included in the RTP header extension of the RTP packet may include data indicating what types of data burst information is included in the RTP header extension. For example, as discussed above, the RTP header extension may include a length value indicating whether the RTP header extension includes either or both of data burst size information and/or a minimum time between bursts or time to next burst (TTNB) value. In some examples, the RTP header extension may include syntax elements (e.g., one-bit flags) for each part of the data burst information, such as a first syntax element (e.g., one bit) for the burst size information and a second syntax element (e.g., one bit) for the idle period/minimum time between bursts/TTNB value, where these syntax elements may each individually indicate whether the corresponding data burst information is included in the RTP header extension.

When data burst information 242 is included in the RTP header extension, UPF device 232 may extract such data burst information from the RTP header extension and add the data burst information to GTP-U packet header 248, as shown in FIG. 4. Likewise, UPF device 232 may also indicate whether the GTP-U packet header includes such data burst information. This indication may be the same as that used in the RTP header extension or a different signaling mechanism. For example, the RTP header extension may include length values and the GTP-U packet header may include syntax elements for each part of the data burst information. As another example, the RTP header extension may include syntax elements for each part of the data burst information and the GTP-U packet header may include a length value indicating which portions of the data burst information are present in the GTP-U packet header.

As still another example, if only idle period/minimum time to next burst/TTNB data is relevant to the base station, UPF device 232 may signal the idle period/minimum time/TTNB data in GTP-U packet header 248, if present in the RTP header extension, without the burst size information. Alternatively, if only the data burst size information is relevant to the base station, UPF device 232 may signal the data burst size information in GTP-U packet header 248, if present in the RTP header extension, without the timing information.

AS device 230 represents an example of a device for sending data via a network. Per techniques of this disclosure, AS device 230 may determine a minimum time between a time of transmission of a current packet (e.g., packet 240) of a packet flow being sent to a client device (e.g., UE device 236) and a time of transmission of a subsequent packet of the packet flow. AS device 230 may also determine a burst size for a data burst including packet 240. In response to determining to signal burst information for packet 240, AS device 230 may send information in the packet (e.g., an RTP header extension) indicating that the burst information is signaled in packet 240.

AS device 230 also signals the burst information. The burst information may include at least one of the minimum time between the time of transmission of packet 240 or the time of transmission of the subsequent packet or the burst size. AS device 230 sends packet 240 to UE device 236. At or after a time corresponding to the minimum time following the time of transmission of packet 240, AS device 230 sends the subsequent packet to UE device 236.

UE device 236 may represent an example of a device for receiving data via a network. UE device 236 receives the data indicating whether burst information is included with packet 240 of the communication session. When the data indicates that packet 240 includes the burst information, UE device 236 determines whether the burst information includes either or both of data representing the minimum time between the time of transmission of packet 240 and the time of transmission of the subsequent packet of the communication session or data representing the burst size for the burst including packet 240. UE device 236 uses the burst information to receive the subsequent packet.

Additionally or alternatively, a base station of RAN 234 may receive the data of the packet indicating whether the packet includes the burst information. When the packet includes the burst information, the base station may extract the burst information and use the burst information to allocate resources for receiving data of the current data burst (or a subsequent data burst). Additionally or alternatively, the base station may configure UE device 236 to enter a low power (e.g., sleep) mode based on the burst information. For example, if the current packet includes data indicating a minimum amount of time until a subsequent packet is transmitted, the base station may configure UE device 236 to enter the low power mode after the packet has been received. As another example, if the current packet includes data indicating the burst size information, the base station may configure UE device 236 to enter the low power mode after the amount of data indicated by the burst size has been received for the current burst.

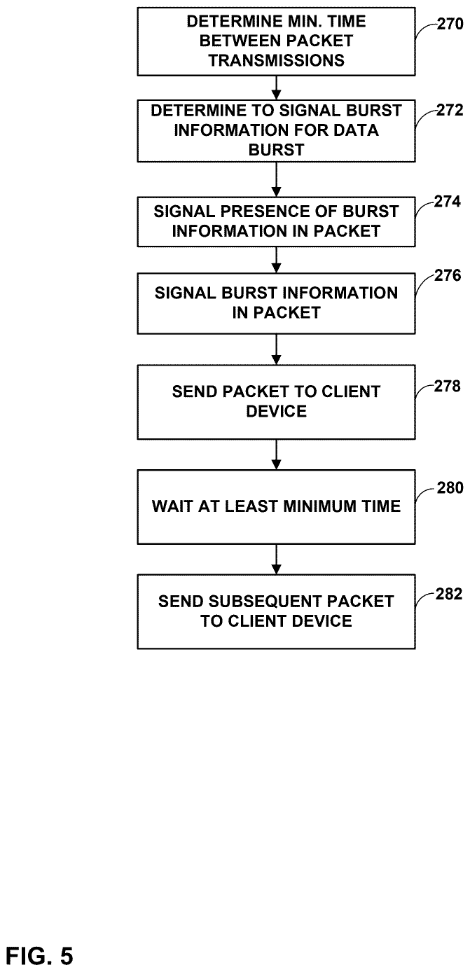

FIG. 5 is a flowchart illustrating an example method of sending data of a communication session via a network according to techniques of this disclosure. For purposes of example and explanation, sending device 200 of FIG. 3 is described as performing the method of FIG. 5. However, other devices, such as content preparation device 20 and/or server device 60 of FIG. 1 or AS device 230 of FIG. 4, may perform this or a similar method.

Initially, in this example, sending device 200 determines a minimum time between a time of transmission of a current packet of a packet flow being sent to a client device (e.g., UE device 208) and a time of transmission of a subsequent packet of the packet flow (270). Sending device 200 may also determine a burst size for a data burst including the current packet. In some examples, the data representing the minimum time between the time of transmission of the current packet and the time of transmission of the subsequent packet comprises data defining an idle time period. In other examples, the data representing the minimum time comprises data defining a time to next burst (TTNB) value. Sending device 200 may calculate the minimum time between the time of transmission of the current packet and the time of transmission of the subsequent packet according to a video encoding delay, wherein the current packet includes encoded video data of a media presentation and the subsequent packet comprises encoded video data of the media presentation.

In response to determining to signal burst information for the current packet (272), sending device 200 signals presence of the burst information in the current packet (274) and signals the burst information (276). To determine whether to signal the burst information for the current packet, sending device 200 may determine whether the minimum time is greater than a threshold, e.g., 1 ms. Sending device 200 may send information to UE device 208 indicating that the burst information is signaled for the current packet and also signal the burst information. The burst information may include either or both of the minimum time between the time of transmission of the current packet and the time of transmission of the subsequent packet and/or the burst size.

In some examples, the burst information signaled by sending device 200 in the packet (e.g., packet 240) may further include PDU set signaling information. A data burst may include one or multiple PDU sets. Sending device 200 may determine to signal the PDU set information within the RTP header extension to facilitate processing of the PDU sets by intermediate devices such as UPF device 202 or by the receiving device, such as UE device 208. The PDU set signaling information may allow base station 206 to perform scheduling optimizations based on the boundaries and characteristics of the PDU sets within the larger data burst.

Additionally or alternatively, the burst information signaled by sending device 200 may include a data boosting indication. Sending device 200 may determine whether a particular data burst or packet flow requires data boosting, for instance, to prioritize delivery or ensure reliability for critical media frames. Sending device 200 may signal this data boosting indication in the RTP header extension. UPF device 202 may extract this indication and forward it to base station 206 via the GTP-U packet header 248 (see FIG. 4), allowing base station 206 to apply appropriate boosting or prioritization techniques for the corresponding radio bearers.

In some examples, the data indicating whether the burst information is included with the current packet comprises a length of a real-time transport protocol (RTP) header extension. In some examples, the data indicating whether the burst information is included with the current packet comprises a first syntax element having a value indicating whether the burst information includes the data representing the minimum time between the time of transmission of the current packet and the time of transmission of a subsequent packet and a second syntax element having a value indicating whether the burst information includes the data representing the burst size. The first syntax element may be a first bit, and the second syntax element may be a second bit.

In some examples, the data indicating whether the burst information is included with the current packet comprises data of a session description protocol (SDP) message. The data may conform to an augmented Backus-Naur form (ABNF) syntax of: extensionname=“urn:3gpp:idle-period:rel-19”; extensionattributes=[format SP]; and format=“short”/“long”. In some examples, the data may conform to an augmented Backus-Naur form (ABNF) syntax of: extensionname=“urn:3gpp:dynamic-traffic-characteristics:rel-19”; extensionattributes=[format SP] fields; format=“short”/“long”; and fields=“idle-period”/“burst-size”/“both”.

Sending device 200 then sends the current packet to UE device 208 (278). Sending device 200 waits at least the minimum time (280). At or after a time corresponding to the minimum time following the time of transmission of the current packet, sending device 200 sends the subsequent packet to UE device 208 (282).

In this manner, the method of FIG. 5 represents an example of a method of sending data via a network, including: determining a minimum time between a time of transmission of a current packet of a packet flow being sent to a client device and a time of transmission of a subsequent packet of the packet flow and a burst size for a data burst including the current packet; in response to determining to signal burst information for the current packet, sending information to the client device indicating that the burst information is signaled for the current packet and signaling the burst information, the burst information including at least one of the minimum time between the time of transmission of the current packet and the time of transmission of the subsequent packet or the burst size; sending the current packet to the client device; and at or after a time corresponding to the minimum time following the time of transmission of the current packet, sending the subsequent packet to the client device.

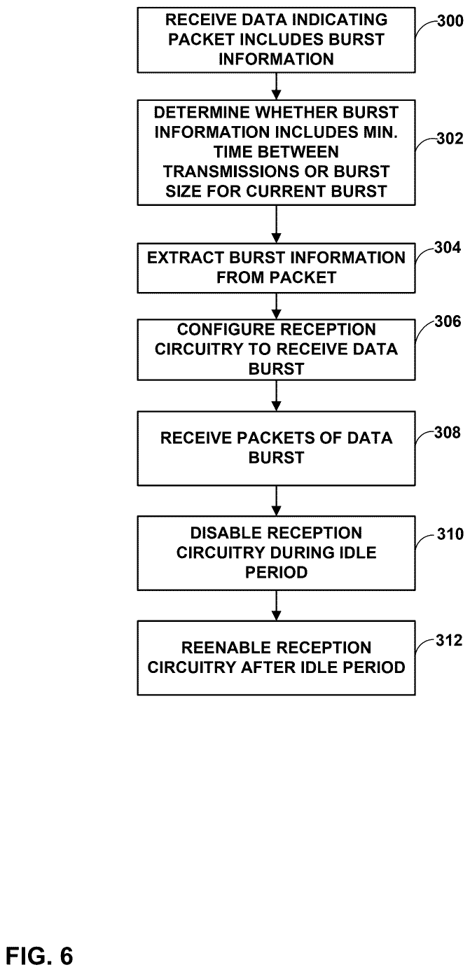

FIG. 6 is a flowchart illustrating an example method of receiving data of a communication session via a network according to techniques of this disclosure. The method of FIG. 6 is described with respect to base station 206 of FIG. 3. However, other devices, such as client device 40 of FIG. 1, UE device 208 of FIG. 3, a base station of RAN 234 of FIG. 4, or UE device 236 of FIG. 4, may be configured to perform this or a similar method.

Initially, base station 206 receives data indicating whether burst information is included with a current packet of a communication session (300). In some examples, the data indicating whether the burst information is included with the current packet comprises a length of a real-time transport protocol (RTP) header extension (e.g., as encapsulated within a tunnel protocol header such as a GTP-U header). Alternatively, the data indicating whether the burst information is included with the current packet comprises data of a session description protocol (SDP) message. The data may conform to an augmented Backus-Naur form (ABNF) syntax of: extensionname=“urn:3gpp:idle-period:rel-19”; extensionattributes=[format SP]; and format=“short”/“long”. Or, the data may conform to an augmented Backus-Naur form (ABNF) syntax of: extensionname=“urn:3gpp:dynamic-traffic-characteristics:rel-19”; extensionattributes=[format SP] fields; format=“short”/“long”; and fields=“idle-period” “burst-size”/“both”.

When the data indicates that the current packet includes the burst information, base station 206 may determine whether the burst information includes either or both of data representing a minimum time between a time of transmission of the current packet and a time of transmission of a subsequent packet of the communication session or data representing a burst size for a burst including the current packet (302). In some examples, the data indicating whether the burst information is included with the current packet comprises a first syntax element having a value indicating whether the burst information includes the data representing the minimum time between the time of transmission of the current packet and the time of transmission of a subsequent packet and a second syntax element having a value indicating whether the burst information includes the data representing the burst size. The first syntax element may be a first bit, and the second syntax element may be a second bit. The data representing the minimum time between the time of transmission of the current packet and the time of transmission of the subsequent packet may comprise data defining an idle time period. Alternatively, the data representing the minimum time may comprise data defining a time to next burst (TTNB) value.

Base station 206 then extracts the burst information from the packet (304). Base station 206 uses the burst information to receive the subsequent packet. For example, base station 206 may configure reception circuitry of UE device 208 to receive the data burst (306). Additionally or alternatively, base station 206 may allocate resources for receiving packets, including the subsequent packet, of the data burst (308). In some examples, when the burst information includes the data representing the minimum time, using the burst information to receive the subsequent packet comprises disabling reception circuitry of UE device 208 for the communication session (310) and, after the minimum time following time of reception of the current packet, reenabling the reception circuitry for the communication session to receive the subsequent packet (312). Receiving the subsequent packet may include receiving the subsequent packet at a time later than the time of reception of the current packet plus the minimum time.

In this manner, the method of FIG. 6 represents an example of a method of receiving data via a network, including: receiving data indicating whether burst information is included with a current packet of a communication session; and when the data indicates that the current packet includes the burst information: determining whether the burst information includes either or both of data representing a minimum time between a time of transmission of the current packet and a time of transmission of a subsequent packet of the communication session or data representing a burst size for a burst including the current packet; and using the burst information to receive the subsequent packet.

Various examples of the techniques of this disclosure are summarized in the following clauses:

Clause 1. A method of receiving data via a network, the method comprising: receiving data indicating whether burst information is included with a current packet of a communication session; when the data indicates that the current packet includes the burst information: determining whether the burst information includes either or both of data representing a minimum time between a time of transmission of the current packet and a time of transmission of a subsequent packet of the communication session or data representing a burst size for a burst including the current packet; and using the burst information to receive the subsequent packet.

Clause 2. The method of clause 1, wherein the data indicating whether the burst information is included with the current packet comprises a length of a real-time transport protocol (RTP) header extension.

Clause 3. The method of clause 1, wherein the data indicating whether the burst information is included with the current packet comprises a first syntax element having a value indicating whether the burst information includes the data representing the minimum time between the time of transmission of the current packet and the time of transmission of a subsequent packet and a second syntax element having a value indicating whether the burst information includes the data representing the burst size.

Clause 4. The method of clause 3, wherein the first syntax element is a first bit, and wherein the second syntax element is a second bit.

Clause 5. The method of clause 1, wherein the data indicating whether the burst information is included with the current packet comprises data of a session description protocol (SDP) message.

Clause 6. The method of clause 5, wherein the data indicating whether the burst information is included with the current packet comprises data conforming to an augmented Backus-Naur form (ABNF) syntax of: extensionname=“urn:3gpp:idle-period:rel-19”; extensionattributes=[format SP]; and format=“short”/“long”.

Clause 7. The method of clause 5, wherein the data indicating whether the burst information is included with the current packet comprises data conforming to an augmented Backus-Naur form (ABNF) syntax of: extensionname=“urn:3gpp:dynamic-traffic-characteristics:rel-19”; extensionattributes=[format SP] fields; format=“short”/“long”; and fields=“idle-period”/“burst-size”/“both”.

Clause 8. The method of any of clauses 1-7, wherein the data representing the minimum time between the time of transmission of the current packet and the time of transmission of the subsequent packet comprises data defining an idle time period.

Clause 9. The method of any of clauses 1-7, wherein the data representing the minimum time between the time of transmission of the current packet and the time of transmission of the subsequent packet comprises data defining a time to next burst (TTNB) value.

Clause 10. The method of any of clauses 1-9, wherein using the burst information to receive the subsequent packet comprises, when the burst information includes the data representing the minimum time between the time of transmission of the current packet and the time of transmission of the subsequent packet: disabling reception circuitry for the communication session; and after the minimum time following time of reception of the current packet, reenabling the reception circuitry for the communication session to receive the subsequent packet.

Clause 11. The method of any of clauses 1-10, wherein receiving the subsequent packet comprises receiving the subsequent packet at a time later than the time of reception of the current packet plus the minimum time.

Clause 12. A method of sending data via a network, the method comprising: determining a minimum time between a time of transmission of a current packet of a packet flow being sent to a client device and a time of transmission of a subsequent packet of the packet flow and a burst size for a data burst including the current packet; in response to determining to signal burst information for the current packet, sending information to the client device indicating that the burst information is signaled for the current packet and signaling the burst information, the burst information including at least one of the minimum time between the time of transmission of the current packet and the time of transmission of the subsequent packet or the burst size; sending the current packet to the client device; and at or after a time corresponding to the minimum time following the time of transmission of the current packet, sending the subsequent packet to the client device.

Clause 13. The method of clause 12, wherein the data indicating whether the burst information is included with the current packet comprises a length of a real-time transport protocol (RTP) header extension.

Clause 14. The method of clause 12, wherein the data indicating whether the burst information is included with the current packet comprises a first syntax element having a value indicating whether the burst information includes the data representing the minimum time between the time of transmission of the current packet and the time of transmission of a subsequent packet and a second syntax element having a value indicating whether the burst information includes the data representing the burst size.

Clause 15. The method of clause 14, wherein the first syntax element is a first bit, and wherein the second syntax element is a second bit.

Clause 16. The method of clause 12, wherein the data indicating whether the burst information is included with the current packet comprises data of a session description protocol (SDP) message.

Clause 17. The method of clause 16, wherein the data indicating whether the burst information is included with the current packet comprises data conforming to an augmented Backus-Naur form (ABNF) syntax of: extensionname=“urn:3gpp:idle-period:rel-19”; extensionattributes=[format SP]; and format=“short”/“long”.

Clause 18. The method of clause 16, wherein the data indicating whether the burst information is included with the current packet comprises data conforming to an augmented Backus-Naur form (ABNF) syntax of: extensionname=“urn:3gpp:dynamic-traffic-characteristics:rel-19”; extensionattributes=[format SP] fields; format=“short”/“long”; and fields=“idle-period”/“burst-size”/“both”.

Clause 19. The method of any of clauses 12-18, wherein the data representing the minimum time between the time of transmission of the current packet and the time of transmission of the subsequent packet comprises data defining an idle time period.

Clause 20. The method of any of clauses 12-18, wherein the data representing the minimum time between the time of transmission of the current packet and the time of transmission of the subsequent packet comprises data defining a time to next burst (TTNB) value.

Clause 21. The method of any of clauses 12-20, further comprising calculating the minimum time between the time of transmission of the current packet and the time of transmission of the subsequent packet according to a video encoding delay, wherein the current packet includes encoded video data of a media presentation and the subsequent packet comprises encoded video data of the media presentation.

Clause 22. A device for receiving data via a network, the device comprising one or more means for performing the method of any of clauses 1-21.

Clause 23. The device of clause 22, wherein the one or more means comprise a memory and a processing system implemented in circuitry.

Clause 24. The device of clause 22, wherein the apparatus comprises at least one of: an integrated circuit; a microprocessor; and a wireless communication device.

Clause 25. A device for retrieving data via a network, the device comprising: means for receiving data indicating whether burst information is included with a current packet of a communication session; means for determining, when the data indicates that the current packet includes the burst information, whether the burst information includes either or both of data representing a minimum time between a time of transmission of the current packet and a time of transmission of a subsequent packet of the communication session or data representing a burst size for a burst including the current packet; and means for, when the data indicates that the current packet includes the burst information, using the burst information to receive the subsequent packet.

Clause 26. A device for sending data via a network, the device comprising: means for determining a minimum time between a time of transmission of a current packet of a packet flow being sent to a client device and a time of transmission of a subsequent packet of the packet flow and a burst size for a data burst including the current packet; means for, in response to determining to signal burst information for the current packet, sending information to the client device indicating that the burst information is signaled for the current packet and signaling the burst information, the burst information including at least one of the minimum time between the time of transmission of the current packet and the time of transmission of the subsequent packet or the burst size; means for sending the current packet to the client device; and means for, at or after a time corresponding to the minimum time following the time of transmission of the current packet, sending the subsequent packet to the client device.

Clause 27. A method of receiving data via a network, the method comprising: receiving data indicating whether burst information is included with a current packet of a communication session; and when the data indicates that the current packet includes the burst information: determining whether the burst information includes either or both of data representing a minimum time between a time of transmission of the current packet and a time of transmission of a subsequent packet of the communication session or data representing a burst size for a burst including the current packet; and using the burst information to receive the subsequent packet.

Clause 28. The method of clause 27, wherein the data indicating whether the burst information is included with the current packet comprises a length of a real-time transport protocol (RTP) header extension.

Clause 29. The method of clause 27, wherein the data indicating whether the burst information is included with the current packet comprises a first syntax element having a value indicating whether the burst information includes the data representing the minimum time between the time of transmission of the current packet and the time of transmission of a subsequent packet and a second syntax element having a value indicating whether the burst information includes the data representing the burst size.

Clause 30. The method of clause 29, wherein the first syntax element is a first bit, and wherein the second syntax element is a second bit.

Clause 31. The method of clause 27, wherein the data indicating whether the burst information is included with the current packet comprises data of a session description protocol (SDP) message.

Clause 32. The method of clause 31, wherein the data indicating whether the burst information is included with the current packet comprises data conforming to an augmented Backus-Naur form (ABNF) syntax of: extensionname=“urn:3gpp:idle-period:rel-19”; extensionattributes=[format SP]; and format=“short”/“long”.

Clause 33. The method of clause 31, wherein the data indicating whether the burst information is included with the current packet comprises data conforming to an augmented Backus-Naur form (ABNF) syntax of: extensionname=“urn:3gpp:dynamic-traffic-characteristics:rel-19”; extensionattributes=[format SP] fields; format=“short”/“long”; and fields=“idle-period”/“burst-size”/“both”.

Clause 34. The method of any of clauses 27-33, wherein the data representing the minimum time between the time of transmission of the current packet and the time of transmission of the subsequent packet comprises data defining an idle time period.

Clause 35. The method of any of clauses 27-33, wherein the data representing the minimum time between the time of transmission of the current packet and the time of transmission of the subsequent packet comprises data defining a time to next burst (TTNB) value.

Clause 36. The method of any of clauses 27-35, wherein using the burst information to receive the subsequent packet comprises, when the burst information includes the data representing the minimum time between the time of transmission of the current packet and the time of transmission of the subsequent packet: disabling reception circuitry for the communication session; and after the minimum time following time of reception of the current packet, reenabling the reception circuitry for the communication session to receive the subsequent packet.

Clause 37. The method of any of clauses 27-36, wherein receiving the subsequent packet comprises receiving the subsequent packet at a time later than the time of reception of the current packet plus the minimum time.

Clause 38. A device for receiving data via a network, the device comprising: a memory configured to store data; and a processing system implemented in circuitry and configured to: receive data indicating whether burst information is included with a current packet of a communication session; and when the data indicates that the current packet includes the burst information: determine whether the burst information includes either or both of data representing a minimum time between a time of transmission of the current packet and a time of transmission of a subsequent packet of the communication session or data representing a burst size for a burst including the current packet; and use the burst information to receive the subsequent packet.

Clause 39. The device of clause 38, wherein the data indicating whether the burst information is included with the current packet comprises a length of a real-time transport protocol (RTP) header extension.

Clause 40. The device of clause 38, wherein the data indicating whether the burst information is included with the current packet comprises a first syntax element having a value indicating whether the burst information includes the data representing the minimum time between the time of transmission of the current packet and the time of transmission of a subsequent packet and a second syntax element having a value indicating whether the burst information includes the data representing the burst size.

Clause 41. The device of clause 40, wherein the first syntax element is a first bit, and wherein the second syntax element is a second bit.

Clause 42. The device of clause 38, wherein the data indicating whether the burst information is included with the current packet comprises data of a session description protocol (SDP) message, the data conforming to an augmented Backus-Naur form (ABNF) syntax of: extensionname=“urn:3gpp:idle-period:rel-19”; extensionattributes=[format SP]; and format=“short”/“long”.

Clause 43. The device of clause 38, wherein the data indicating whether the burst information is included with the current packet comprises data of a session description protocol (SDP) message, the data conforming to an augmented Backus-Naur form (ABNF) syntax of: extensionname=“urn: 3gpp: dynamic-traffic-characteristics:rel-19”; extensionattributes=[format SP] fields; format=“short”/“long”; and fields=“idle-period”/“burst-size”/“both”.

Clause 44. A method of sending data via a network, the method comprising: determining a minimum time between a time of transmission of a current packet of a packet flow being sent to a client device and a time of transmission of a subsequent packet of the packet flow and a burst size for a data burst including the current packet; in response to determining to signal burst information for the current packet, sending information to the client device indicating that the burst information is signaled for the current packet and signaling the burst information, the burst information including at least one of the minimum time between the time of transmission of the current packet and the time of transmission of the subsequent packet or the burst size; sending the current packet to the client device; and at or after a time corresponding to the minimum time following the time of transmission of the current packet, sending the subsequent packet to the client device.

Clause 45. The method of clause 44, wherein the data indicating whether the burst information is included with the current packet comprises a length of a real-time transport protocol (RTP) header extension.

Clause 46. The method of clause 44, wherein the data indicating whether the burst information is included with the current packet comprises a first syntax element having a value indicating whether the burst information includes the data representing the minimum time between the time of transmission of the current packet and the time of transmission of a subsequent packet and a second syntax element having a value indicating whether the burst information includes the data representing the burst size.

Clause 47. The method of clause 46, wherein the first syntax element is a first bit, and wherein the second syntax element is a second bit.

Clause 48. The method of clause 44, wherein the data indicating whether the burst information is included with the current packet comprises data of a session description protocol (SDP) message.

Clause 49. The method of clause 48, wherein the data indicating whether the burst information is included with the current packet comprises data conforming to an augmented Backus-Naur form (ABNF) syntax of: extensionname=“urn:3gpp:idle-period:rel-19”; extensionattributes=[format SP]; and format=“short”/“long”.

Clause 50. The method of clause 48, wherein the data indicating whether the burst information is included with the current packet comprises data conforming to an augmented Backus-Naur form (ABNF) syntax of: extensionname=“urn:3gpp: dynamic-traffic-characteristics:rel-19”; extensionattributes=[format SP] fields; format=“short”/“long”; and fields=“idle-period”/“burst-size”/“both”.

Clause 51. The method of any of clauses 44-50, wherein the data representing the minimum time between the time of transmission of the current packet and the time of transmission of the subsequent packet comprises data defining an idle time period.

Clause 52. The method of any of clauses 44-50, wherein the data representing the minimum time between the time of transmission of the current packet and the time of transmission of the subsequent packet comprises data defining a time to next burst (TTNB) value.

Clause 53. The method of any of clauses 44-52, further comprising calculating the minimum time between the time of transmission of the current packet and the time of transmission of the subsequent packet according to a video encoding delay, wherein the current packet includes encoded video data of a media presentation and the subsequent packet comprises encoded video data of the media presentation.

Clause 54. A device for sending data via a network, the device comprising: a memory configured to store data; and a processing system implemented in circuitry and configured to: determine a minimum time between a time of transmission of a current packet of a packet flow being sent to a client device and a time of transmission of a subsequent packet of the packet flow and a burst size for a data burst including the current packet; in response to determining to signal burst information for the current packet, send information to the client device indicating that the burst information is signaled for the current packet and signaling the burst information, the burst information including at least one of the minimum time between the time of transmission of the current packet and the time of transmission of the subsequent packet or the burst size; send the current packet to the client device; and at or after a time corresponding to the minimum time following the time of transmission of the current packet, send the subsequent packet to the client device.

Clause 55. The device of clause 54, wherein the data indicating whether the burst information is included with the current packet comprises a length of a real-time transport protocol (RTP) header extension.

Clause 56. The device of clause 54, wherein the data indicating whether the burst information is included with the current packet comprises a first syntax element having a value indicating whether the burst information includes the data representing the minimum time between the time of transmission of the current packet and the time of transmission of a subsequent packet and a second syntax element having a value indicating whether the burst information includes the data representing the burst size.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of receiving data via a network, the method comprising:
receiving data indicating whether burst information is included with a current packet of a communication session; and
when the data indicates that the current packet includes the burst information:
determining whether the burst information includes either or both of data representing a minimum time between a time of transmission of the current packet and a time of transmission of a subsequent packet of the communication session or data representing a burst size for a burst including the current packet; and
using the burst information to receive the subsequent packet.

2. The method of claim 1, wherein the data indicating whether the burst information is included with the current packet comprises a length of a real-time transport protocol (RTP) header extension.

3. The method of claim 1, wherein the data indicating whether the burst information is included with the current packet comprises a first syntax element having a value indicating whether the burst information includes the data representing the minimum time between the time of transmission of the current packet and the time of transmission of a subsequent packet and a second syntax element having a value indicating whether the burst information includes the data representing the burst size.

4. The method of claim 3, wherein the first syntax element is a first bit, and wherein the second syntax element is a second bit.

5. The method of claim 1, wherein the data indicating whether the burst information is included with the current packet comprises data of a session description protocol (SDP) message.

6. The method of claim 5, wherein the data indicating whether the burst information is included with the current packet comprises data conforming to an augmented Backus-Naur form (ABNF) syntax of:
extensionname=“urn:3gpp:idle-period:rel-19”;
extensionattributes=[format SP]; and
format=“short”/“long”.

7. The method of claim 5, wherein the data indicating whether the burst information is included with the current packet comprises data conforming to an augmented Backus-Naur form (ABNF) syntax of:
extensionname=“urn:3gpp:dynamic-traffic-characteristics:rel-19”;
extensionattributes=[format SP] fields;
format=“short”/“long”; and
fields=“idle-period” “burst-size”/“both”.

8. The method of claim 1, wherein the data representing the minimum time between the time of transmission of the current packet and the time of transmission of the subsequent packet comprises data defining an idle time period.

9. The method of claim 1, wherein the data representing the minimum time between the time of transmission of the current packet and the time of transmission of the subsequent packet comprises data defining a time to next burst (TTNB) value.

10. The method of claim 1, wherein using the burst information to receive the subsequent packet comprises, when the burst information includes the data representing the minimum time between the time of transmission of the current packet and the time of transmission of the subsequent packet:
disabling reception circuitry for the communication session; and
after the minimum time following a time of reception of the current packet, reenabling the reception circuitry for the communication session to receive the subsequent packet.

11. The method of claim 1, wherein receiving the subsequent packet comprises receiving the subsequent packet at a time later than a time of reception of the current packet plus the minimum time.

12. A device for receiving data via a network, the device comprising:
a memory configured to store data; and
a processing system implemented in circuitry and configured to:
receive data indicating whether burst information is included with a current packet of a communication session; and
when the data indicates that the current packet includes the burst information:
determine whether the burst information includes either or both of data representing a minimum time between a time of transmission of the current packet and a time of transmission of a subsequent packet of the communication session or data representing a burst size for a burst including the current packet; and
use the burst information to receive the subsequent packet.

13. The device of claim 12, wherein the data indicating whether the burst information is included with the current packet comprises a length of a real-time transport protocol (RTP) header extension.

14. The device of claim 12, wherein the data indicating whether the burst information is included with the current packet comprises a first syntax element having a value indicating whether the burst information includes the data representing the minimum time between the time of transmission of the current packet and the time of transmission of a subsequent packet and a second syntax element having a value indicating whether the burst information includes the data representing the burst size.

15. The device of claim 14, wherein the first syntax element is a first bit, and wherein the second syntax element is a second bit.

16. The device of claim 12, wherein the data indicating whether the burst information is included with the current packet comprises data of a session description protocol (SDP) message, the data conforming to an augmented Backus-Naur form (ABNF) syntax of:
extensionname=“urn:3gpp:idle-period:rel-19”;
extensionattributes=[format SP]; and
format=“short”/“long”.

17. The device of claim 12, wherein the data indicating whether the burst information is included with the current packet comprises data of a session description protocol (SDP) message, the data conforming to an augmented Backus-Naur form (ABNF) syntax of:
extensionname=“urn:3gpp:dynamic-traffic-characteristics:rel-19”;
extensionattributes=[format SP] fields;
format=“short”/“long”; and
fields=“idle-period” “burst-size”/“both”.

18. A method of sending data via a network, the method comprising:
determining a minimum time between a time of transmission of a current packet of a packet flow being sent to a client device and a time of transmission of a subsequent packet of the packet flow and a burst size for a data burst including the current packet;
in response to determining to signal burst information for the current packet, sending information to the client device indicating that the burst information is included for the current packet and signaling the burst information, the burst information including at least one of the minimum time between the time of transmission of the current packet and the time of transmission of the subsequent packet or the burst size;
sending the current packet to the client device; and
at or after a time corresponding to the minimum time following the time of transmission of the current packet, sending the subsequent packet to the client device.

19. The method of claim 18, wherein the information indicating that the burst information is included with the current packet comprises a length of a real-time transport protocol (RTP) header extension.

20. The method of claim 18, wherein the information indicating that the burst information is included with the current packet comprises a first syntax element having a value indicating whether the burst information includes data representing the minimum time between the time of transmission of the current packet and the time of transmission of a subsequent packet and a second syntax element having a value indicating whether the burst information includes data representing the burst size.

21. The method of claim 20, wherein the first syntax element is a first bit, and wherein the second syntax element is a second bit.

22. The method of claim 18, wherein the information indicating that the burst information is included with the current packet comprises data of a session description protocol (SDP) message.

23. The method of claim 22, wherein the information indicating that the burst information is included with the current packet comprises data conforming to an augmented Backus-Naur form (ABNF) syntax of:
extensionname=“urn:3gpp:idle-period:rel-19”;
extensionattributes=[format SP]; and
format=“short”/“long”.

24. The method of claim 22, wherein the information indicating that the burst information is included with the current packet comprises data conforming to an augmented Backus-Naur form (ABNF) syntax of:
extensionname=“urn:3gpp:dynamic-traffic-characteristics:rel-19”;
extensionattributes=[format SP] fields;
format=“short”/“long”; and
fields=“idle-period” “burst-size”/“both”.

25. The method of claim 18, wherein the burst information includes data representing the minimum time between the time of transmission of the current packet and the time of transmission of the subsequent packet, the data representing the minimum time comprising data defining an idle time period.

26. The method of claim 18, wherein the burst information includes data representing the minimum time between the time of transmission of the current packet and the time of transmission of the subsequent packet, the data representing the minimum time comprising data defining a time to next burst (TTNB) value.

27. The method of claim 18, further comprising calculating the minimum time between the time of transmission of the current packet and the time of transmission of the subsequent packet according to a video encoding delay, wherein the current packet includes encoded video data of a media presentation and the subsequent packet comprises encoded video data of the media presentation.

28. A device for sending data via a network, the device comprising:
a memory configured to store data; and
a processing system implemented in circuitry and configured to:
determine a minimum time between a time of transmission of a current packet of a packet flow being sent to a client device and a time of transmission of a subsequent packet of the packet flow and a burst size for a data burst including the current packet;
in response to determining to signal burst information for the current packet, send information to the client device indicating that the burst information is signaled for the current packet and signaling the burst information, the burst information including at least one of the minimum time between the time of transmission of the current packet and the time of transmission of the subsequent packet or the burst size;
send the current packet to the client device; and
at or after a time corresponding to the minimum time following the time of transmission of the current packet, send the subsequent packet to the client device.

29. The device of claim 28, wherein the information indicating that the burst information is included with the current packet comprises a length of a real-time transport protocol (RTP) header extension.

30. The device of claim 28, wherein the information indicating that the burst information is included with the current packet comprises a first syntax element having a value indicating whether the burst information includes data representing the minimum time between the time of transmission of the current packet and the time of transmission of a subsequent packet and a second syntax element having a value indicating whether the burst information includes data representing the burst size.
